(19) United States
(12) Patent Application Publication
(10) Pub. No.: US 2026/0023248 A1
(43) Pub. Date: Jan. 22, 2026

(54) ZOOM LENS MODULE

(71) Applicant: Luxvisions Innovation Technology Corp. Limited, Guangzhou City (CN)

(72) Inventor: Chuan-hui LIU, Guangzhou City (CN)

(21) Appl. No.: 19/183,889

(22) Filed: Apr. 20, 2025

(30) Foreign Application Priority Data
Jul. 22, 2024 (CN) 202410980733.X

(51) Int. Cl. G02B 15/14

(52) U.S. Cl. CPC G02B 15/143507

(57) ABSTRACT

A zoom lens module is provided. The zoom lens module includes a first lens group configured as a fixed lens group and positioned near an object side, a second lens group configured as a movable lens group and disposed adjacent to the first lens group; and a third lens group configured as a movable lens group, disposed adjacent to the second lens group, positioned near an image side. The first lens group, the second lens group, and the third lens group are arranged along an optical axis, and an equivalent focal length of the zoom lens module is adjustable by changing the positions of the second lens group and the third lens group to perform zooming.

### CROSS REFERENCE TO RELATED APPLICATIONS

This application claims priority to China Application Serial No. 202410980733.X, filed July 22, 2024, the disclosure of which is incorporated herein by reference.

### FIELD OF DISCLOSURE

The present application relates to a zoom lens, particularly relates to a zoom lens module including multiple lens assemblies, wherein zooming is performed by adjusting the equivalent focal length through changing the positions of a second lens group and a third lens group.

### BACKGROUND

Generally, a long-focus zoom effect is achieved by incorporating multiple lenses. However, such techniques usually involve complex optical paths and device configurations due to the integration of multiple lenses. Additionally, sophisticated control and corresponding algorithms are required to coordinate the operation of multiple lenses when capturing fast-moving objects.

Moreover, image distortion, edge blurring, and other problems arise due to the instability of optical path in conventional zooming method, and image resolution may decrease when the conventional zoom method is used to capture images. The issues mentioned above require improvement in this field.

### SUMMARY OF DISCLOSURE

The present application provides a zoom lens module to realize optical zoom by moving two lens assemblies thereby generating different optical magnifications. Additionally, the present application reduces computational burdens, simplifies the optical path, and significantly enhances imaging clarity. However, the above description is merely illustrative, and the scope of the present application is not limited thereto.

In one aspect, the present application provides a zoom lens module including a first lens group, a second lens group and a third lens group. The first lens group is configurated as a fixed lens group and positioned near an object side. The second lens group is configured as a movable lens group and disposed adjacent to the first lens group. The third lens group is configured as a movable lens group, disposed adjacent to the second lens group and near an image side. Wherein, the first lens group, the second lens group and the third lens group are arranged along an optical axis. An equivalent focal length of the zoom lens module is adjustable by changing the positions of the second lens group and the third lens group to perform zooming.

In some embodiments, a spacing between the second lens group and the third lens group satisfies the following condition: 2.5 < (H/d10) < 3.5, wherein H is a diagonal length of a sensor in the zoom lens module, and d10 is a maximum spacing distance between a side of the second lens group proximal to the image side and a side of the third lens group proximal to the object side.

In some embodiments, image plane compensation is performed by driving the second lens group and the third lens group to correct an imaging position of the zoom lens module after movement to respective magnification positions during zooming.

In some embodiments, image plane compensation is performed by driving the second lens group and the third lens group to correct an imaging position of the zoom lens module during focusing.

In some embodiments, the first lens group has a negative focal power, and the first lens group remains fixed along the optical axis when the zoom lens module transitions from a wide-angle state to a long-focus state.

In some embodiments, the second lens group has a positive focal power, and the second lens group moves from the image side to the object side when the zoom lens module transitions from a wide-angle state to a long-focus state.

In some embodiments, the third lens group has a positive focal power, and the third lens group moves from the image side to the object side when the zoom lens module transitions from a wide-angle state to a long-focus state.

In some embodiments, the zoom lens module includes a first lens, a second lens, a third lens, a fourth lens, a fifth lens, a sixth lens, a seventh lens, and an eighth lens arranged sequentially from the object side to the image side. When the first lens is a negative lens, the second lens is a positive lens, and when the first lens is a positive lens, the second lens is a negative lens.

In some embodiments, the zoom lens module includes a first lens, a second lens, a third lens, a fourth lens, a fifth lens, a sixth lens, a seventh lens, and an eighth lens arranged sequentially from the object side to the image side. When the second lens is a negative lens, the third lens is a negative lens, and when the second lens is a positive lens, the third lens is a positive lens.

In some embodiments, the zoom lens module includes a first lens, a second lens, a third lens, a fourth lens, a fifth lens, a sixth lens, a seventh lens, and an eighth lens arranged sequentially from the object side to the image side. The fourth lens is a positive lens, the sixth lens is a positive lens, the seventh lens is a positive lens, and the eighth lens is a negative lens.

In some embodiments, the zoom lens module further includes a first lens, a second lens, a third lens, a fourth lens, a fifth lens, a sixth lens, a seventh lens, and an eighth lens arranged sequentially from the object side to the image side. The fifth lens is either a positive lens or a negative lens.

In some embodiments, the zoom lens module satisfies the following conditions: 3 < T/H < 5, and 1.5 < (T*fw) / (H * ft) < 2.5. Wherein, H is a diagonal length of a sensor in the zoom lens module, T is a total length of the zoom lens module, ft is an equivalent focal length at a long-focus end of the zoom lens module, and fw is an equivalent focal length at a wide-angle end of the zoom lens module.

The zoom lens module of the present application provides at least the following advantages:

The embodiments of the invention enable the zoom lens module to perform zooming by adjusting the positions of the second lens group and the third lens group to change the equivalent focal length of the zoom lens module. Additionally, the zoom lens module can adjust the imaging magnification and perform image plane compensation by comprehensively moving the lens assemblies during the zooming process.

With a segmented lens group design, the present application can adaptively adjust the optical magnification, reduce the computational burden on the device, simplify the optical path, and significantly enhance imaging clarity.

The specific embodiments of the present application will be illustrated by the following detailed description, accompanied by the attached drawings, thereby making the objectives, technical content, characteristics, and achieved effects of the present application more comprehensible.

### BRIEF DESCRIPTION OF DRAWINGS

FIGS. 1a to 1d illustrate schematic optical path diagrams of Configurations 1 to 4 of a zoom lens module in a first embodiment in accordance with the present application.

FIGS. 2a and 2b are optical performance analysis diagrams of Configuration 1 of the zoom lens module shown in FIGS. 1a.

FIGS. 3a and 3b are optical performance analysis diagrams of Configuration 2 of the zoom lens module shown in FIG. 1b.

FIGS. 4a and 4b are optical performance analysis diagrams of Configuration 3 of the zoom lens module shown in FIG. 1c.

FIGS. 5a and 5b are optical performance analysis diagrams of Configuration 4 of the zoom lens module shown in FIG. 1d.

FIGS. 6a to 6d illustrate schematic optical path diagrams of Configurations 1 to 4 of a zoom lens module in a second embodiment in accordance with the present application.

FIGS. 7a and 7b are optical performance analysis diagrams of Configuration 1 of the zoom lens module shown in FIG. 6a.

FIGS. 8a and 8b are optical performance analysis diagrams of Configuration 2 of the zoom lens module shown in FIG. 6b.

FIGS. 9a and 9b are optical performance analysis diagrams of Configuration 3 of the zoom lens module shown in FIG. 6c.

FIGS. 10a and 10b are optical performance analysis diagrams of Configuration 4 of the zoom lens module shown in FIG. 6d.

FIGS. 11a to 11d illustrate schematic optical path diagrams of Configurations 1 to 4 of a zoom lens module in a third embodiment in accordance with the present application.

FIGS. 12a and 12b are optical performance analysis diagrams of Configuration 1 of the zoom lens module shown in FIG. 11a.

FIGS. 13a and 13b are optical performance analysis diagrams of Configuration 2 of the zoom lens module shown in FIG. 11b.

FIGS. 14a and 14b are optical performance analysis diagrams of Configuration 3 of the zoom lens module shown in FIG. 11c.

FIGS. 15a and 15b are optical performance analysis diagrams of Configuration 4 of the zoom lens module shown in FIG. 11d.

### DETAILED DESCRIPTION

Exemplary embodiments will now be described more fully with reference to the accompanying drawings. However, the exemplary embodiments can be implemented in various forms and should not be construed as being limited to the examples set forth herein. On the contrary, providing these embodiments makes the present disclosure more comprehensive and complete, and fully conveys the concept of the exemplary embodiments to those skilled in the art. The drawings are only schematic illustrations of the present disclosure and are not necessarily drawn to scale. The same reference numerals in the figures denote the same or similar parts, and thus their repeated description will be omitted.

The terminology used herein is for the purpose of describing particular embodiments and is not intended to limit the present application. As used herein, the singular forms 'a,' 'an,' and 'the' are also intended to include their plural forms unless the context clearly dictates otherwise. It should also be understood that the terms 'include' and/or 'comprise,' as used in this specification, specify the presence of stated features, elements, steps, operations, components, and/or groups thereof, but do not preclude the presence or addition of one or more other features, elements, steps, operations, components, and/or groups thereof.

The embodiments of the present application are described with reference to schematic diagrams illustrating multiple idealized embodiments (and various intermediate structures). Therefore, due to factors such as manufacturing techniques and tolerances, various modifications to the illustrated structures are foreseeable. Accordingly, the embodiments of the present application should not be construed as being limited to the specific shapes illustrated herein but should also encompass variations resulting from manufacturing deviations.

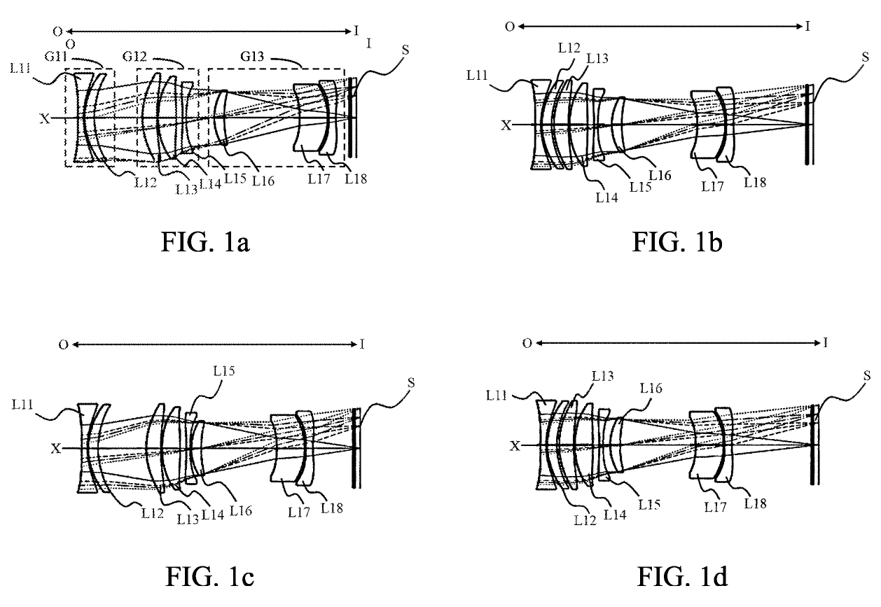

Referring to FIGS. 1a to 1d, FIGS. 1a to 1d illustrate schematic optical path diagrams of Configurations 1 to 4 of a zoom lens module in a first embodiment in accordance with the present application. In the first embodiment, the zoom lens module includes a first lens group G11, a second lens group G12, and a third lens group G13 arranged sequentially from an object side O to an image side I. The first lens group G11 is configured as a fixed lens group. The second lens group G12 is configured as a movable lens group and is disposed adjacent to the first lens group G11. The third lens group G13 is configured as a movable lens group and is disposed adjacent to the second lens group G12. The first lens group G11, the second lens group G12 and the third lens group G13 are arranged along an optical axis X, and an equivalent focal length of the zoom lens module is adjustable by changing the positions of the second lens group G12 and the third lens group G13 to perform zooming.

The first lens group G11 includes a first lens L11 and a second lens L12. The second lens group G12 includes a third lens L13, a fourth lens L14, and a fifth lens L15. The third lens group G13 includes a sixth lens L16, a seventh lens L17, and an eighth lens L18.

In the first embodiment, FIG. 1a discloses the relative positions of the first lens group G11, the second lens group G12, and the third lens group G13 when the zoom lens module is in a long-focus state with a focal length of 900 mm (Configuration 1). FIG. 1b discloses the relative positions of the first lens group G11, the second lens group G12, and the third lens group G13 when the zoom lens module is in a wide-angle state with a focal length of 75 mm (Configuration 2). FIG. 1c discloses the relative positions of the first lens group G11, the second lens group G12, and the third lens group G13 when the zoom lens module is in the long-focus state with an infinite focal length (Configuration 3). FIG. 1d discloses the relative positions of the first lens group G11, the second lens group G12, and the third lens group G13 when the zoom lens module is in the wide-angle state with an infinite focal length (Configuration 4).

As shown in FIGS. 1a to 1d, when the zoom lens module is in the long-focus state with the focal length of 900 mm, the first lens group G11 and the second lens group G12 are spaced apart from each other to allow light to pass through the second lens L12 first and then diverge upward or downward in an interval between the first lens group G11 and the second lens group G12. The second lens group G12 is disposed adjacent to the third lens group G13, and the light is converged toward the optical axis X in an interval between the second lens group G12 and the third lens group G13 by passing through the fourth lens L14. Compared to Configurations 2, 3, and 4, the eighth lens L18 in the third lens group G13 is positioned closer to the image side I in Configuration 1 than in Configurations 2, 3, and 4. When the zoom lens module is in the wide-angle state of Configurations 2 and 4, the second lens group G12 is disposed closely adjacent to the first lens group G11. That is, when the zoom lens module of the first embodiment is in the wide-angle state, the distance between the third lens L13 and the second lens L12 is shorter than when the zoom lens module is in the long-focus state.

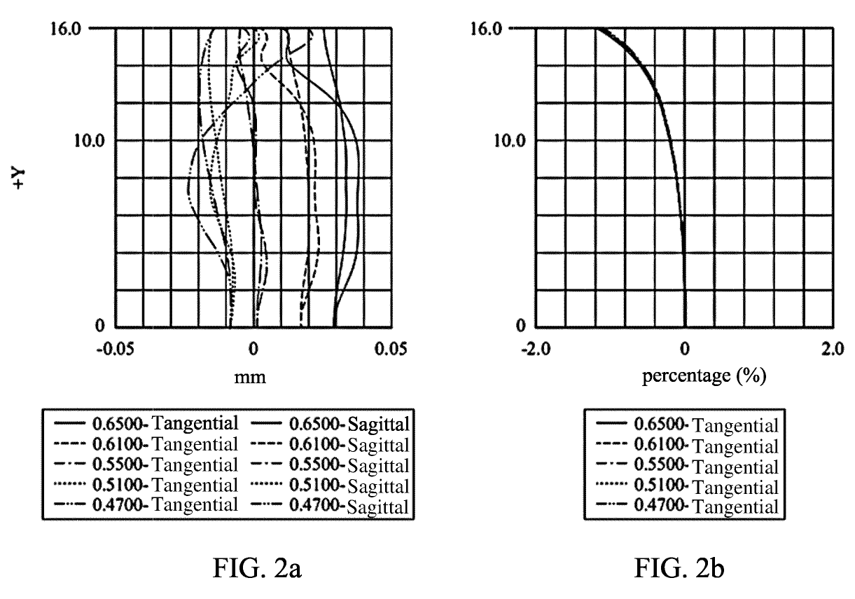

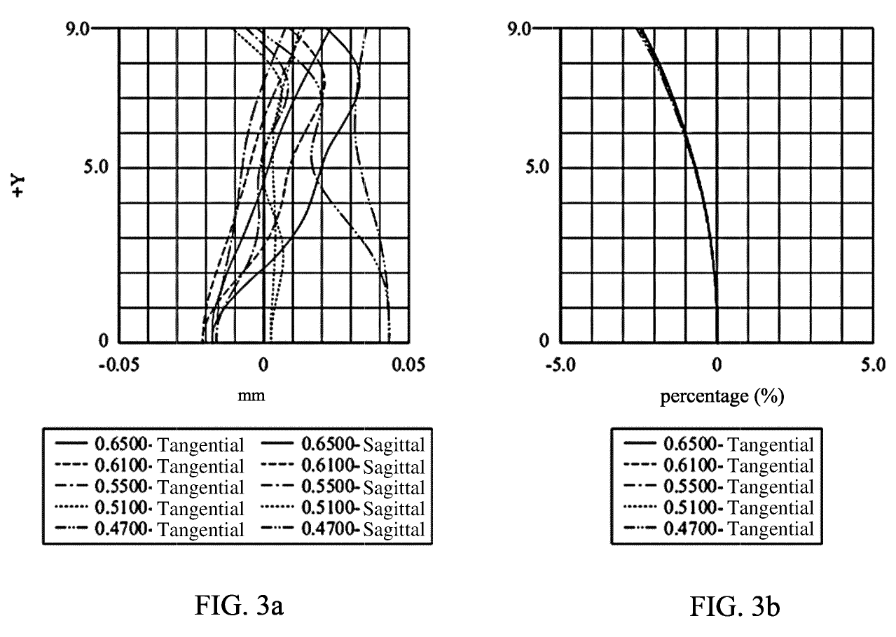

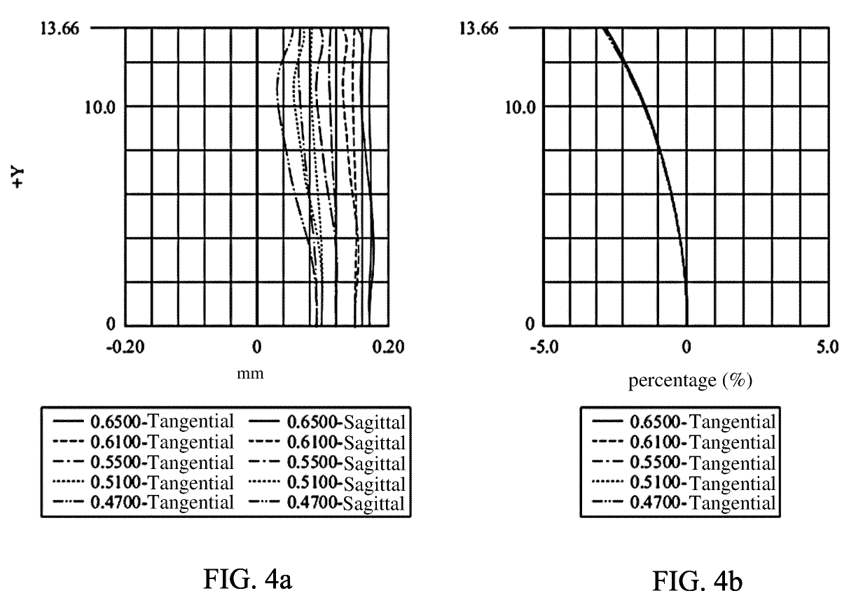

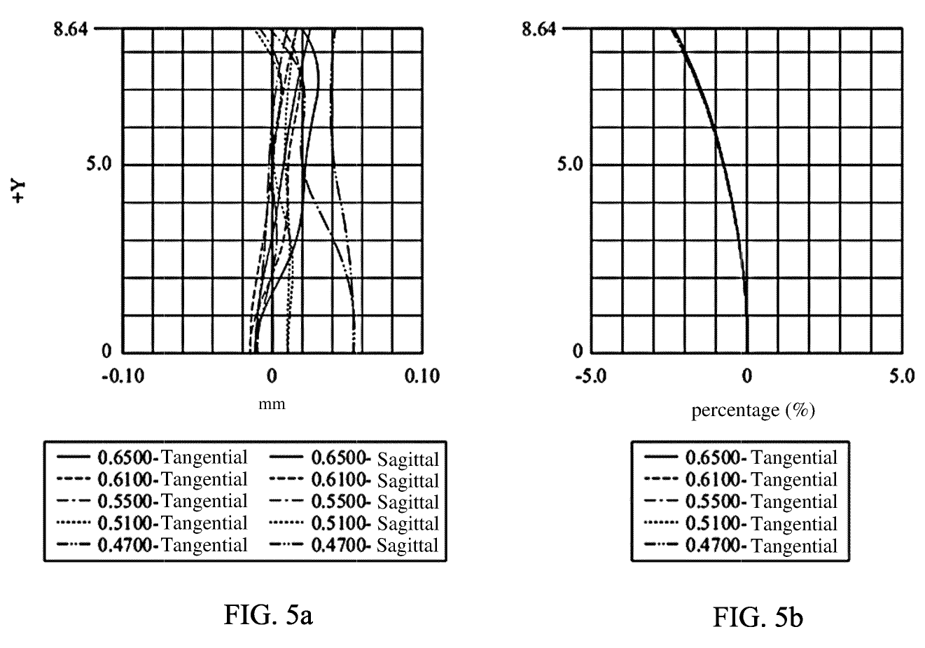

FIGS. 2 to 5 respectively illustrate optical performance analysis diagrams of Configurations 1 to 4 of the zoom lens module, as shown in FIGS. 1a to 1d. Wherein, FIGS. 2a, 3a, 4a, and 5a illustrate analysis diagrams of the field curvature of Configurations 1 to 4 in the first embodiment, while FIGS. 2b, 3b, 4b, and 5b illustrate analysis diagrams of the distortion of Configurations 1 to 4 in the first embodiment.

As shown in FIGS. 2 to 5, an image distortion rate remains below 3%, and both a tangential field curvature value and a sagittal field curvature value are less than 0.2 mm. Therefore, the zoom lens module of the first embodiment can continuously adjust the focal length during the transition between the wide-angle state and the long-focus state to prevent imaging distortion and to maintain high image clarity.

In one embodiment of the present application, the second lens group G12 and the third lens group G13 are driven by, but not limited to, a dual motor. When the focal length of the zoom lens module needs to be adjusted, it is achieved by moving the second lens group G12 and the third lens group G13. During the zooming process of the zoom lens module, image plane compensation is performed by driving the second lens group G12 and the third lens group G13 to correct an imaging position of the zoom lens module after the second lens group G12 and the third lens group G13 moves to their corresponding magnification positions.

Alternatively, in another embodiment of the present application, during the focusing process of the zoom lens module, image plane compensation is performed by driving the second lens group G12 and the third lens group G13 to correct their imaging position.

In one embodiment of the present application, the first lens group G11 has a negative focal power. When the zoom lens module transitions from the wide-angle state to the long-focus state, the first lens group G11 remains fixed along the optical axis.

In one embodiment of the present application, a spacing between the second lens group G12 and the third lens group G13 satisfies the condition: 2.5 < (H/d10) < 3.5, where H is the diagonal length of a sensor in the zoom lens module, and d10 is a maximum spacing distance between a side of the second lens group G12 near the image side I and a side of the third lens group G13 near the object side O.

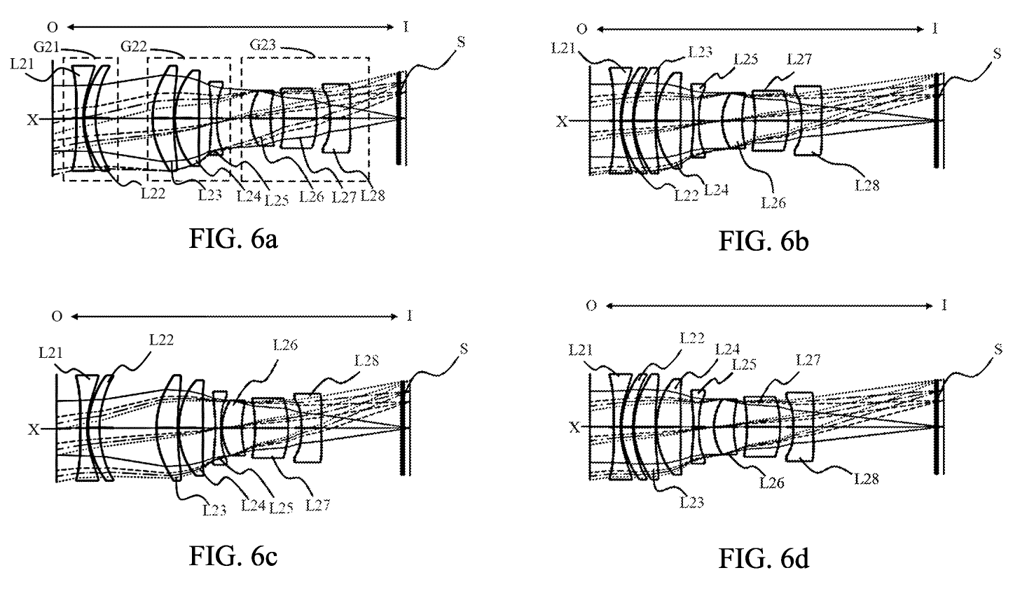

Referring to FIGS. 6a to 6d, FIGS. 6a to 6d illustrate optical path diagrams of Configurations 1 to 4 of a zoom lens module according to a second embodiment of the present application. In the second embodiment, the zoom lens module includes a first lens group G21, a second lens group G22, and a third lens group G23 arranged sequentially from the object side O to the image side I. The first lens group G21 is configured as a fixed lens group. The second lens group G22 is configured as a movable lens group. The third lens group G23 is also configured as a movable lens group. Wherein, the first lens group G21, the second lens group G22 and the third lens group G23 are arranged along an optical axis X, and an equivalent focal length of the zoom lens module is adjustable by changing positions of the second lens group G22 and the third lens group G23 to perform zooming.

The first lens group G21 includes a first lens L21 and a second lens L22. The second lens group G22 includes a third lens L23, a fourth lens L24, and a fifth lens L25. The third lens group G23 includes a sixth lens L26, a seventh lens L27, and an eighth lens L28.

In the second embodiment, as shown in FIG. 6, FIG. 6a discloses the relative positions of the first lens group G21, the second lens group G22, and the third lens group G23 in the second embodiment when the zoom lens module is in a wide-angle state with an infinite focal length (Configuration 1). FIG. 6b discloses the relative positions of the first lens group G21, the second lens group G22, and the third lens group G23 when the zoom lens module is in a long-focus state with an infinite focal length (Configuration 2). FIG. 6c discloses the relative positions of the first lens group G21, the second lens group G22 and the third lens group G23 when the zoom lens module is in the wide-angle state with a focal length of 75 mm (Configuration 3). FIG. 6d discloses the relative positions of the first lens group G21, the second lens group G22 and the third lens group G23 when the zoom lens module is in the long-focus state with a focal length of 900 mm (Configuration 4).

In the second embodiment of the present application, the second lens group G22 has a positive focal power. When the zoom lens module transitions from the wide-angle state to the long-focus state, the second lens group G22 moves from the image side I toward the object side O.

In the second embodiment of the present application, the third lens group G23 has a positive focal power. When the zoom lens module transitions from the wide-angle state to the long-focus state, the third lens group G23 moves from the image side I toward the object side O.

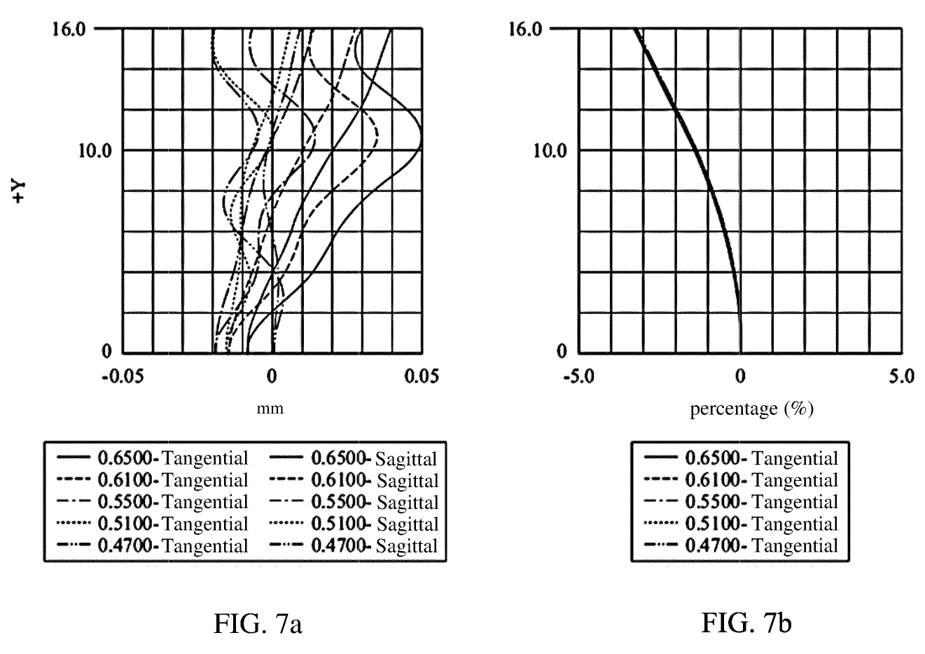

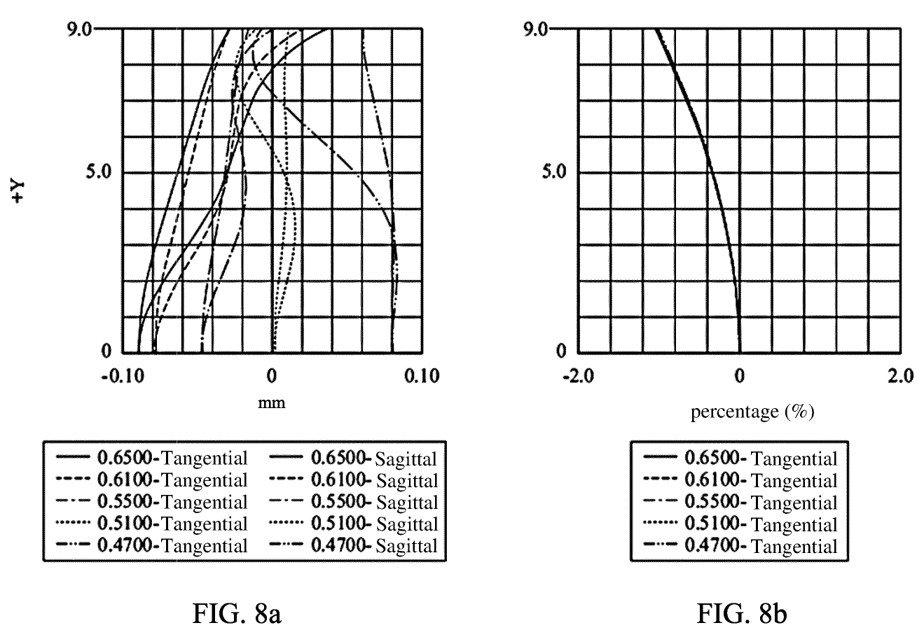

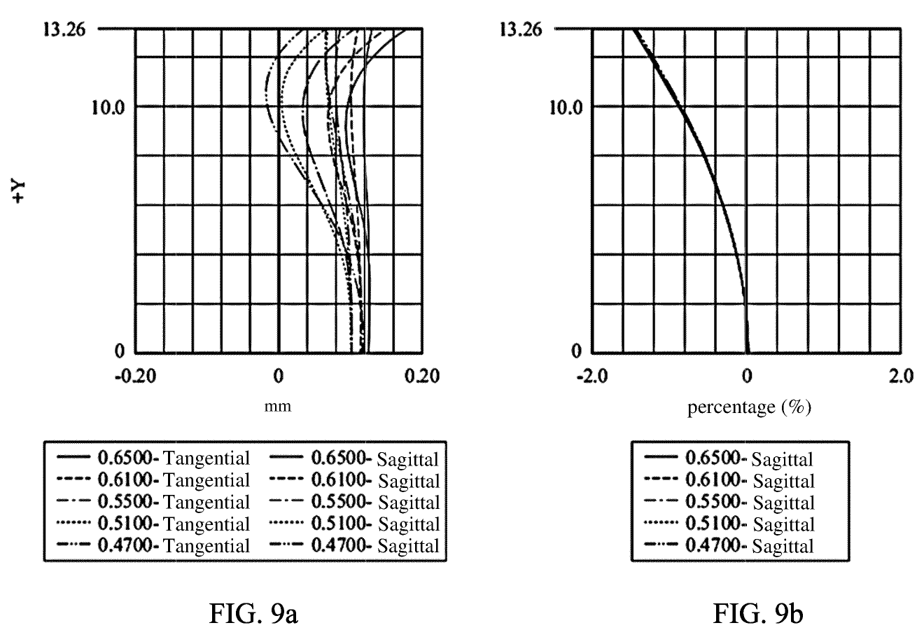

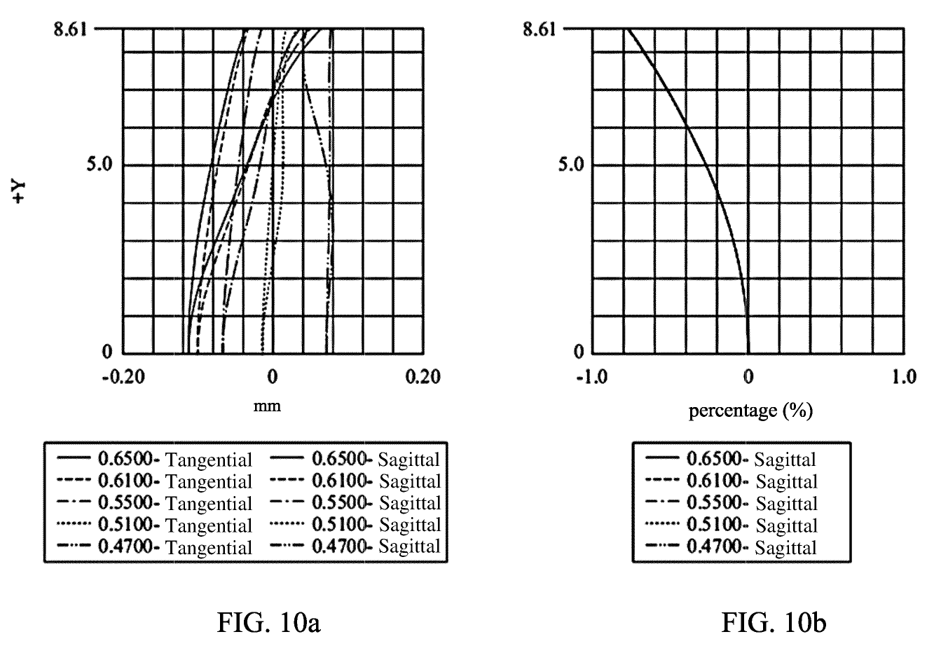

FIGS. 7 to 10 respectively illustrate optical performance analysis diagrams of Configurations 1 to 4 of the zoom lens module as shown in FIGS. 6a to 6d. Wherein, FIGS. 7a, 8a, 9a, and 10a illustrate analysis diagrams of the field curvature of Configurations 1 to 4 in the second embodiment, while FIGS. 7b, 8b, 9b, and 10b illustrate analysis diagrams of the distortion of Configurations 1 to 4 in the second embodiment.

As shown in FIGS. 7 to 10, the image distortion rate remains below 3%, and both a tangential field curvature value and a sagittal field curvature value are less than 0.2 mm. Therefore, the zoom lens module of the second embodiment can continuously adjust the focal length during the transition between the wide-angle state and the long-focus state to prevent imaging distortion and to maintain high image clarity.

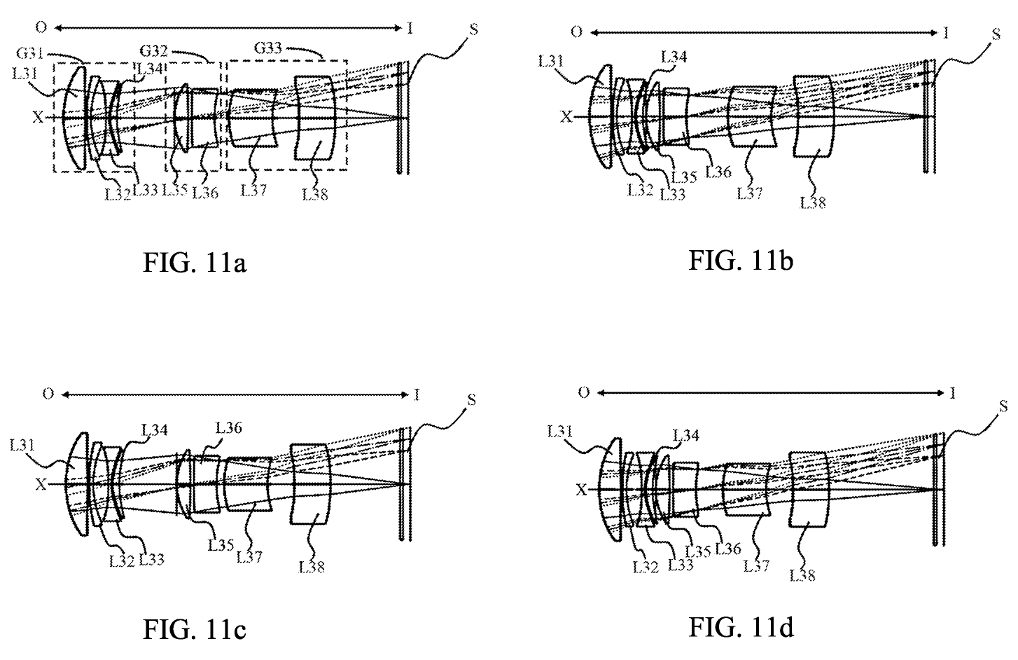

Referring to FIGS. 11a to 11d, FIGS. 11a to 11d illustrate optical path diagrams of Configurations 1 to 4 of a zoom lens module according to a third embodiment in the present application. In the third embodiment, the zoom lens module includes a first lens group G31, a second lens group G32, and a third lens group G33 arranged sequentially from the object side O to the image side I. The first lens group G31 is configured as a fixed lens group. The second lens group G32 is configured as a movable lens group. The third lens group G33 is configured as a movable lens group. The first lens group G31, the second lens group G32 and the third lens group G33 are arranged along an optical axis X, and an equivalent focal length of the zoom lens module is adjustable by changing positions of the second lens group G32 and the third lens group G33 to perform zooming.

The first lens group G31 includes a first lens L31, a second lens L32, a third lens L33, and a fourth lens L34. The second lens group G32 includes a fifth lens L35 and a sixth lens L36. The third lens group G33 includes a seventh lens L37 and an eighth lens L38.

In the third embodiment, as shown in FIG. 11, FIG. 11a discloses the relative positions of the first lens group G31, the second lens group G32 and the third lens group G33 when the zoom lens module is in a wide-angle state with an infinite focal length (Configuration 1). FIG. 11b discloses the positions of the first lens group G31, the second lens group G32 and the third lens group G33 when the zoom lens module is in a long-focus state with an infinite focal length (Configuration 2). FIG. 11c discloses the relative positions of the first lens group G31, the second lens group G32 and the third lens group G33 when the zoom lens module is in the wide-angle state with a focal length of 1000 mm (Configuration 3). FIG. 11d discloses the relative positions of the first lens group G31, the second lens group G32 and the third lens group G33 when the zoom lens module is in the long-focus state with a focal length of 1000 mm (Configuration 4).

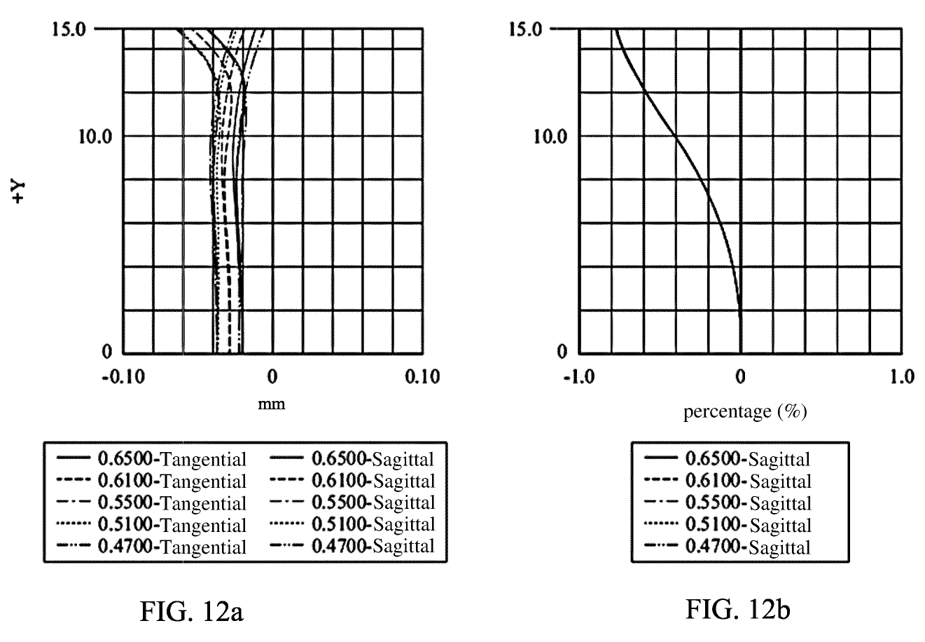

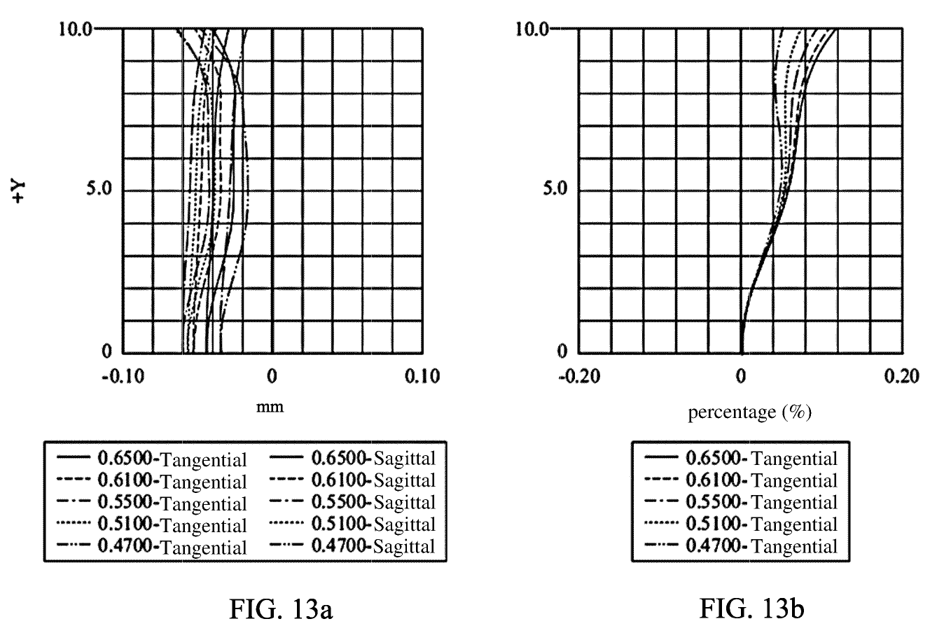

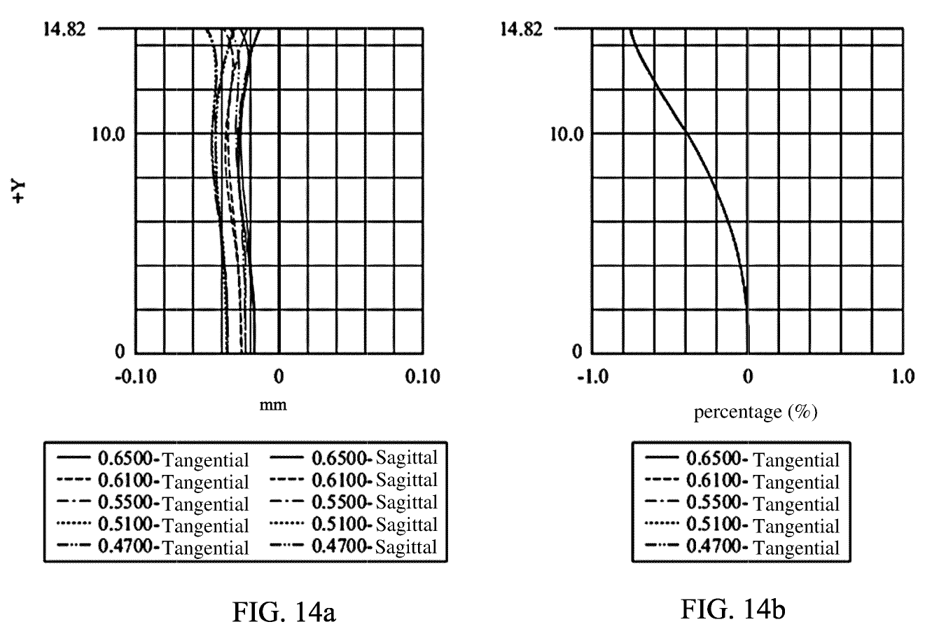

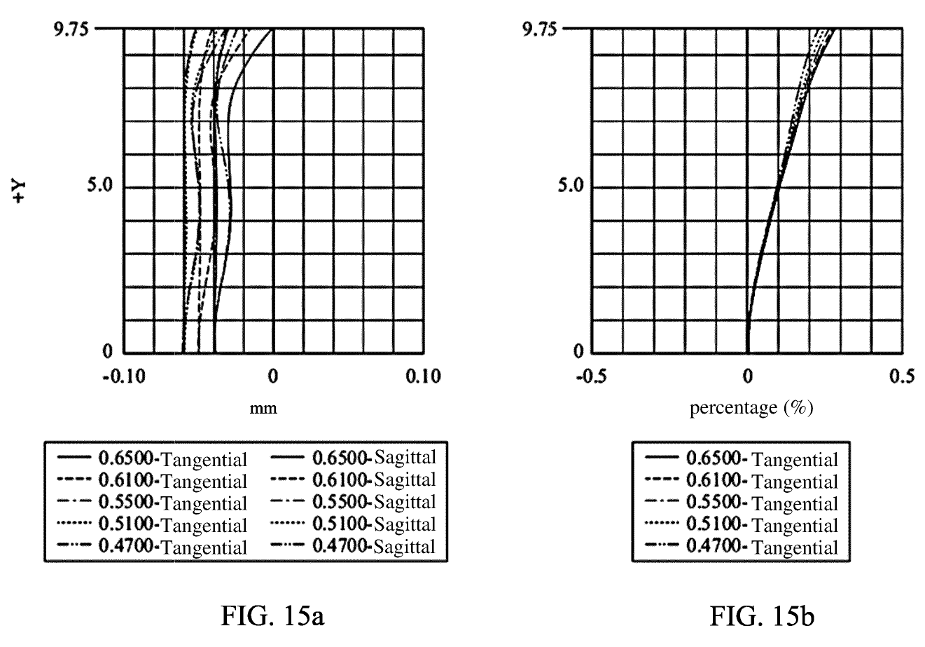

FIGS. 12 to 15 respectively illustrate optical performance analysis diagrams of Configurations 1 to 4 of the zoom lens module as shown in FIG. 11. Wherein, FIGS. 12a, 13a, 14a, and 15a illustrate analysis diagrams of the field curvature of Configurations 1 to 4 in the third embodiment, while FIGS. 12b, 13b, 14b, and 15b illustrate analysis diagrams of the distortion of Configurations 1 to 4 in the third embodiment.

As shown in FIGS. 12 to 15, an image distortion rate remains below 3%, and both a tangential field curvature value and a sagittal field curvature value are less than 0.2 mm. Therefore, the zoom lens module of the third embodiment can continuously adjust the focal length during the transition between the wide-angle state and the long-focus state to prevent imaging distortion and to maintain high image clarity.

In the third embodiment of the present application, the second lens group G32 has a positive focal power. When the zoom lens module transitions from the wide-angle state to the long-focus state, the second lens group G32 moves from the image side I toward the object side O.

In the third embodiment of the present application, the third lens group G33 has a positive focal power. When the zoom lens module transitions from the wide-angle state to the long-focus state, the third lens group G33 moves from the image side I toward the object side O.

However, the embodiments of the present application are not limited to the three embodiments described above. In one embodiment, the zoom lens module includes a first lens, a second lens, a third lens, a fourth lens, a fifth lens, a sixth lens, a seventh lens, and an eighth lens sequentially arranged from the object side to the image side. When the first lens is a negative lens, the second lens is a positive lens; and when the first lens is a positive lens, the second lens is a negative lens.

In one embodiment of the present application, when the second lens is a negative lens, the third lens is a negative lens; when the second lens is a positive lens, the third lens is also a positive lens.

In one embodiment, the fourth lens is a positive lens, the sixth lens is a positive lens, the seventh lens is a positive lens, and the eighth lens is a negative lens.

In one embodiment, the fifth lens may be either a positive lens or a negative lens.

Furthermore, the zoom lens module provided in the present application satisfies the following conditions: 3 < T/H < 5; and 1.5 < (T *fw) / (H* ft) < 2.5, where H is the diagonal length of a sensor in the zoom lens module, T is the total length of the zoom lens module, ft is the equivalent focal length at a long-focus end, and fw is the equivalent focal length at a wide-angle end.

With this design, the zoom lens module provided in the present application enables precise imaging while performing continuously zooming. For example, when applied to a mobile phone camera, the zoom lens module can achieve continuous optical zoom within a magnification range of 3 to 5, facilitating control via a motor.

According to the multiple embodiments of the present application described above, the zoom lens module performs zooming by adjusting the positions of the second lens group and the third lens group to change the equivalent focal length of the zoom lens module. Additionally, the zoom lens module can adjust the imaging magnification and perform image plane compensation by comprehensively moving the lens assemblies during the zooming process. With a segmented lens group design, the zoom lens module can adaptively adjust the optical magnification, reduce the computational burden on the device, simplify the optical path, and significantly enhance imaging clarity. However, the scope of the present application is not limited to the aforementioned advantages.

Although the present application has been specifically illustrated and described with reference to its embodiments, persons skilled in the art will understand that various modifications in form and detail can be made without departing from the scope of the invention as defined by the following claims.

What is claimed is:

1. A zoom lens module, comprising:
a first lens group configured as a fixed lens group and positioned near an object side;
a second lens group configured as a movable lens group and disposed adjacent to the first lens group; and
a third lens group configured as a movable lens group, disposed adjacent to the second lens group and near an image side;
wherein the first lens group, the second lens group and the third lens group are arranged along an optical axis, and an equivalent focal length of the zoom lens module is adjustable by changing the positions of the second lens group and the third lens group to perform zooming.

2. The zoom lens module according to claim 1, wherein a spacing between the second lens group and the third lens group satisfies the following condition:
2.5 < (H/d10) < 3.5;
wherein H is a diagonal length of a sensor in the zoom lens module, and d10 is a maximum spacing distance between a side of the second lens group proximal to the image side and a side of the third lens group proximal to the object side.

3. The zoom lens module according to claim 1, wherein an image plane compensation is performed by driving the second lens group and the third lens group to correct an imaging position of the zoom lens module after movement to respective magnification positions during zooming.

4. The zoom lens module according to claim 1, wherein an image plane compensation is performed by driving the second lens group and the third lens group to correct an imaging position of the zoom lens module during focusing.

5. The zoom lens module according to claim 1, wherein the first lens group has a negative focal power, and the first lens group remains fixed along the optical axis when the zoom lens module transitions from a wide-angle state to a long-focus state.

6. The zoom lens module according to claim 1, wherein the second lens group has positive focal power, and the second lens group moves from the image side to the object side when the zoom lens module transitions from a wide-angle state to a long-focus state.

7. The zoom lens module according to claim 1, wherein the third lens group has positive focal power, and the third lens group moves from the image side to the object side when the zoom lens module transitions from a wide-angle state to a long-focus state.

8. The zoom lens module according to claim 1, comprising a first lens, a second lens, a third lens, a fourth lens, a fifth lens, a sixth lens, a seventh lens, and an eighth lens arranged sequentially from the object side to the image side, wherein when the first lens is a negative lens, the second lens is a positive lens, and when the first lens is a positive lens, the second lens is a negative lens.

9. The zoom lens module according to claim 1, comprising a first lens, a second lens, a third lens, a fourth lens, a fifth lens, a sixth lens, a seventh lens, and an eighth lens arranged sequentially from the object side to the image side, wherein when the second lens is a negative lens, the third lens is a negative lens, and when the second lens is a positive lens, the third lens is a positive lens.

10. The zoom lens module according to claim 1, comprising a first lens, a second lens, a third lens, a fourth lens, a fifth lens, a sixth lens, a seventh lens, and an eighth lens arranged sequentially from the object side to the image side, wherein the fourth lens is a positive lens, the sixth lens is a positive lens, the seventh lens is a positive lens, and the eighth lens is a negative lens.

11. The zoom lens module according to claim 1, comprising a first lens, a second lens, a third lens, a fourth lens, a fifth lens, a sixth lens, a seventh lens, and an eighth lens arranged sequentially from the object side to the image side, wherein the fifth lens is either a positive lens or a negative lens.

12. The zoom lens module according to claim 1, wherein the zoom lens module satisfies the following conditions:
3 < T/H < 5; and
1.5 < (T*fw) / (H * ft) < 2.5;
wherein H is a diagonal length of a sensor in the zoom lens module, T is a total length of the zoom lens module, ft is an equivalent focal length at a long-focus end of the zoom lens module, and fw is an equivalent focal length at a wide-angle end of the zoom lens module.
